(19) United States
(12) Patent Application Publication
(10) Pub. No.: US 2017/0221040 A1
(43) Pub. Date: Aug. 3, 2017

(54) METHOD AND APPARATUS FOR ASSISTANCE IN LAYAWAY SHOPPING

(71) Applicant: Steven Ringo, Marrero, LA (US)

(72) Inventor: Steven Ringo, Marrero, LA (US)

(21) Appl. No.: 15/009,341

(22) Filed: Jan. 28, 2016

(51) Int. Cl. G06Q 20/28; G06Q 30/06; G06Q 20/32

(52) U.S. Cl. CPC G06Q 20/28; G06Q 20/3224; G06Q 20/3276; G06Q 30/0633

(57) ABSTRACT

The present invention discloses a method and apparatus for a customer to purchase an item or items on “layaway,” that is, by purchasing a product by placing a deposit on the item. The disclosed invention provides for a cell phone application, or “app,” that would assist a shopper in making such a layaway purchase. The disclosed app allows the user, as a physical customer inside a retail store, to scan an item that the user is interested in purchasing, and then purchase the item via stored merchandise data if so desired.

### BACKGROUND OF THE INVENTION

The present invention provides a method and apparatus for a customer to purchase an item or items on “layaway,” that is, by purchasing a product by placing a deposit on the item. The disclosed invention provides for a cell phone application, or “app,” that would assist a shopper in making such a layaway purchase. The disclosed app allows the user, as a physical customer inside a retail store, to scan an item that the user is interested in purchasing, and then purchase the item via stored merchandise data if so desired.

Retail stores often offer the option of purchasing an item whereby the purchaser is not obligated to pay the full price of the item at the time of purchase. Instead, the purchaser may select the item, pay a fraction of the total purchase price, and then pay the remainder of the price at a later date. Upon payment of the total purchase price, at the later date, the purchaser may then take physical custody of the item purchased. Such a purchase is referred to colloquially as a “layaway” purchase, and retailers may implement variations of a layaway system tailored to suit the retailer's individual concerns. For example, the retailer may require that the initial, layaway payment cost a set percentage of the total purchase price, or may require a certain set price for all layaway purchases. Additionally, the retailer may vary the delivery method of the item being purchased; it may require the purchaser to return to the store to buy the item at the later date, or may coordinate direct delivery to the purchaser on the date of the final payment. Regardless of the various approaches to the layaway system, most systems tend to require an upfront payment of a certain amount, but the customer does not take physical possession of the item until a later date.

The layaway system offers advantages to both retailer and purchaser, making it an attractive retail technique. From the perspective of the retailer, it guarantees the sale of an item without immediately depleting the in-store inventory of the item. For example, some retailers, such as furniture stores, may only have one or two models of a particular item in stock in its physical store. If a purchaser buys the item on layaway, the purchaser does not remove the item from the store at that time, and so the retailer may keep the item in the store to sell to a subsequent customer. The retailer may then remotely order additional sold items, as needed to complete the layaway purchases, because there is sufficient time to ship in the item from the distribution center. In some layaway systems, the retailer may also benefit from the sale of the layaway price if the customer ultimately decides not to pay the remainder of the purchase price. Because the initial, layaway payment acts as a deposit on the purchased item, the customer only owns the item after payment of the full price. If, upon further review of the purchase, the customer decides not to pay the remainder of the purchase price, the sale is cancelled but the retailer retains the initial layaway payment, thus profiting from the cancelled sale.

From the customer's perspective, a layaway purchase offers a highly convenient manner of purchase. Due to the structure of the layaway purchase, the customer pays a lower amount at the time of sale than the higher, total price of the retail item. Such an option is especially attractive to customers when they are planning to purchase relatively expensive items or a large quantity of retail items within a short timeframe. The initial layaway payment may allow for the customer to make a purchase that they may not have been able to afford otherwise, because it allows for the customer to save and ultimately provide the total purchase price at a later date.

Despite the attractiveness of the payment system of the layaway method, customers may be reluctant to engage in layaway shopping for a several reasons. First, because the customer is not able to take physical possession of the item at its time of purchase, a customer may consider it too much of a hassle to wait in the payment lines at a retail store to purchase the product. When unable to take a product out of the store, the customer may believe it is not worth it to engage in the busy atmosphere and long lines of the retail store, and may instead choose to order the item online or by some other means. At the same time, a customer may wish to physically see the product that is being purchased, rather than relying on an online or virtual representation of the product. There thus exists a need for retailers to offer the option to the customer to make an in-store purchase without having to wait in line to ring up the sale. This in-store but “remote” purchase option is particularly applicable to the layaway system since the customer is not removing the item from the store at the time of purchase.

Second, when making layaway purchases, the amount of the initial layaway payment may be confusing to a customer. Because the layaway purchase price is generally not reflected on the price tag of the item, the customer may be unable to mentally calculate the correct layaway price of the item. Further, different stores may have different layaway pricing policies, thus preventing the customer from easily tracking how much he or she is meant to pay for the item at the time of sale. Also, if the customer is purchasing multiple items on layaway, or mixing a layaway purchase with normal, full-price purchases, it may be difficult for the customer to track how much payment will be owed to the retailer at the time of sale. There thus exists a need for a customer to have a means for determining the appropriate amount of payment due to the retailer at the time of a layaway sale.

Several methods and systems have attempted to offer various in-store shopping assistance to customers. For example, U.S. Pat. No. 7,689,473, issued Mar. 30, 2010 to Danielle L. Borom for “Method for Generating a Shopping List Using Virtual Merchandising Options,” discloses an enhanced shopping system for facilitating grocery shopping and in-store advertising. The system changed the way grocery retail industry captures and retains customers, how customers organize their shopping efforts in grocery stores, the approach to advertising and researching customers, and the information available to retailers and merchandisers related to customer shopping patterns, responses to merchandising and advertising, and specific impact of discounting/coupons. The Borom system provides for a methodology comprising storing in a computer memory device a plurality of retail items available for purchase in a retail store defining stored retail items; providing an electronic interface for enabling customers to select retail items stored in said computer memory device defining selected retail items; providing an option to a manufacturer to acquire a virtual merchandising option for one or more retail items which associates one or more of a manufacturer's branded retail items with one or more retail items in said computer memory device; creating by a digital computer under program control an electronic shopping list of said selected retail items; determining for each said selected retail item whether said virtual merchandising option has been acquired, and if said virtual merchandising option has been acquired, then maintaining said manufacturer's branded retail item, or if said virtual merchandising option has not been acquired, then switching said selected retail item on said shopping list to a generic shopping list and item; and then displaying said electronic shopping list with aid manufacturer branded retail items and said generic shopping list items on an electronic display.

U.S. Pat. No. 8,403,215, issued Mar. 26, 2013 to Toru Aihara et al. for “Self Shopping Support by Getting Contents from Electronic Shelf Labels,” discloses offering support to a shopper to perform self-service shopping by using an electronic shelf label (ESL) while looking at actual items displayed in a store and to expand the functions of the electronic shelf label (ESL) to enable the linkage with other data processing systems expansively. A shopper uses a mobile processing device (typically, a cell phone owned by the shopper) in a store. The functions necessary to obtain contents form the electronic shelf label (ESL) are obtained by introducing an application program into the shopper's own cell phone, by which it is expected that the shopper is able to easily enjoy shopping. When photographing the electronic shelf label (ESL), the contents associated with items are encoded (the price display automatically changing to a barcode), and then decoded.

U.S. Patent Publication No. 2014/0019317, published Jan. 16, 2014 to Wenceslao Casares et al. for “Transaction Managing System,” discloses embodiments related generally to systems, methods, devices, and computer-readable media for capturing details of a transaction, extracting details of the transaction, categorizing details of the transaction, storing details of the transaction, and creating customizable reports of the details of the transaction in numerical or graphical form and advertising on savings for past and/or future transactions.

U.S. Patent Publication No. 2012/0173351, published Jul. 5, 2012 to David J. Hansen et al. for “Mobile Electronic Shopping,” discloses electronic shopping and payment embodiments which utilize a software program running on a device to digitally photograph a machine-readable representation of data, including but not limited to a UPC, a digital photograph of a product or product identification code, a voice representation of a product or product identification code, or the manual entry of a product identification code to identify products, which are then stored on a client or server in a virtual shopping cart. Virtual shopping cart items are purchased through an electronic payment system from the mobile device using a client and server. The physical representation of these items may be located in an actual shopping cart in a brick and mortar store, or virtually located through the Internet.

U.S. Pat. No. 8,849,703, issued Sep. 30, 2014 to Arjun Ramaratnam et al. for “Processing Online Transactions,” discloses systems and methods for managing transactions in which an order is specified online and payment is received at a point of sale (POS). Methods are disclosed for managing payment for such transactions at a POS, including transactions involving payment for both in-store purchases and online orders. Methods are also disclosed for managing inventory and price changes for such transactions where payment can occur at any time in a pay period following order creation. Also disclosed are methods for processing refunds for online orders for which payment was made at a POS. Finally, methods for preventing fraud and abuse, as well as restricting the availability of this payment method for certain methods, are disclosed.

U.S. Pat. No. 8,838,477, issued Sep. 16, 2014 to Mehran Moshfeghi for “Method and System for Communicating Location of a Mobile Device for Hands-Free Payment,” discloses a method and system for communicating the location of a mobile device for hands-free payment, which may include a peer-to-peer ad-hoc network that comprises a plurality of mobile devices, a plurality of access points, and a plurality of point of sale (POS) devices. A first mobile device may determine its location coordinates and then communicate such coordinates to a selected POS device via the peer-to-peer ad-hoc network. At least one of the plurality of mobile devices and/or the plurality of access points may be within a defined proximity of the selected POS device. In some instances, the first POS device may receive, via one or more intermediate mobile devices in the peer-to-peer ad-hoc network, location coordinates and payment transaction information of a selected mobile device. At least one of the intermediate mobile devices may be within a defined proximity of the first POS device.

U.S. Patent Publication No. 2015/0120475, published Apr. 30, 2015 to Douglas Pedley et al. for “Executing an In-Store Transaction,” discloses a computer-implemented process that includes a hand-held communications device to generate a list reflecting contents of a shopping cart. This includes scanning a QR code provided at a point of sale and transmitting the list reflecting contents of the shopping cart to a server. The server communicates the contents of the shopping cart to the point of sale. A bill of sale corresponding to the list reflecting the contents of the shopping cart is generated at the point of sale. A payment is tendered to complete the sale at the point of sale.

U.S. Patent Publication No. 2015/0102102, published Apr. 16, 2015 to Thomas Heim et al. for “System for Inventory Tracking and Monitoring Using a Database of Low-Power Active Tags and a Method for Its Use,” discloses a device and a system for very low power wireless communication between small transceivers, which are applied to objects and remote databases or programs. The disclosed device and system requires so little energy that ordinary inexpensive coin cells can power a transceiver for many years. The system disclosed in the Heim publication gives the benefit of true bi-directional interactive communication but at a very low cost and power requirement. The transceiver has the ability to respond using its own power source, representing an advance in the state of the art over traditional RFID methods.

There is therefore a need in the art for an in-store virtual system that allows a customer to make a layaway purchase. It is one of the objects of the present invention to provide for such a system, which allows for a customer to make a layaway purchase through an electronic device, such as a mobile phone.

It is a further object of the present invention to offer a customer the ability to view the cost of the initial, layaway payment of the item or items being purchased.

It is a further object of the present invention to offer a customer the ability to review the cost of the initial, layaway payment of an item or items as compared to the prices of the item or items in other retail stores.

It is a further object of the present invention to offer a customer the ability to make a layaway purchase without having to wait in a retail line to purchase the product.

### SUMMARY OF THE INVENTION

The present invention provides a method and system that achieves the above objectives by a cell phone application, or “app,” that would assist a shopper in making a layaway purchase. The disclosed app allows the user, as a physical customer inside a retail store, to scan an item that the user is interested in purchasing, and then purchase the item via stored merchandise data if so desired. The use of such an app would allow the customer to easily calculate and track the layaway cost of the item being purchased, and would allow the customer to purchase the item through the app so that it is not necessary to wait in line to complete the layaway purchase.

### BRIEF DESCRIPTION OF DRAWINGS

Reference will now be made to the drawings, wherein like parts are designated by like numerals, and wherein:

FIG. 1 is a flowchart depicting the steps utilized in one embodiment of the disclosed invention;

FIG. 2 is a flowchart depicting the steps utilized in another alternative embodiment of the disclosed invention; and

FIG. 3 is a flowchart depicting the steps utilized in another alternative embodiment of the disclosed invention.

### DETAILED DESCRIPTION OF THE INVENTION

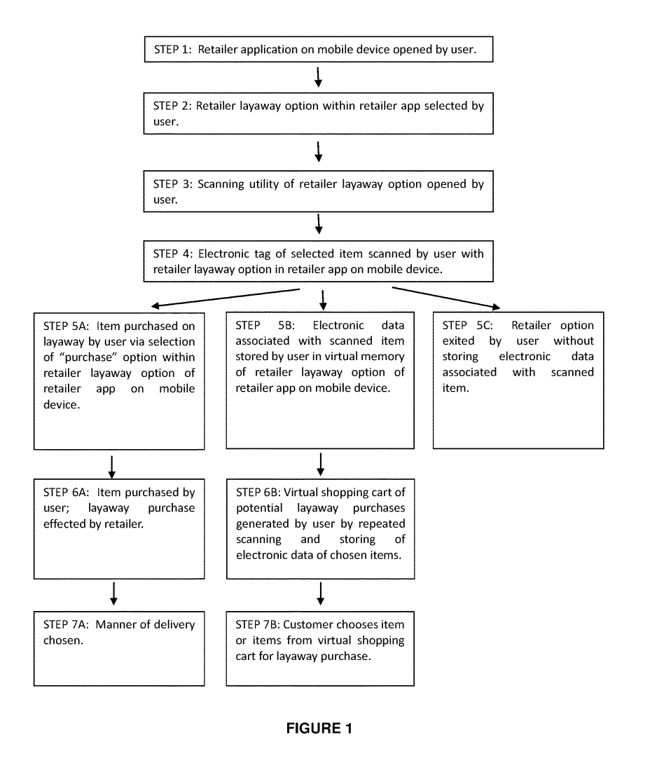

Referring to FIGS. 1-3 generally, the figures depict flowcharts outlining the steps incorporated into various embodiments of the layaway app of the present invention.

A first embodiment, as shown in FIG. 1, may be implemented through an integration with the retailer's own mobile application. Many retailers may already utilize an electronic marking system as disclosed in the above-referenced prior art. In such a retail store, the inventory may have electronic data stored in the retail system's electronic database. The electronic data associated with a particular item may be read by the retailer's electronic system via the scanning of an electronic tag or identifier, or Electronic Shelf Label (ESL), associated with the tag. In integrating this retail system with the application of the present invention, the customer may use a mobile app to scan such an electronic tag. Means for such a mobile scan of the electronic tag are known in the art, as discussed in, for example, U.S. Pat. No. 8,403,215 on “Self Shopping Support by Getting Contents from Electronic Shelf Labels.” In a system wherein the retail has created its own mobile application (a “retailer app”), the customer may have previously installed the retailer app for use in scanning electronic tags of chosen items in the retail store while shopping.

In Step 1 of this retailer-implemented embodiment, as shown in FIG. 1, the customer would open the retailer app on his or her mobile device. The retailer app would then include a feature in its own app specifically designed for layaway purchases (the “retailer layaway option”). Such a retailer layaway option may be indicated in the application via, for example, a virtual button on the home screen or other screen of the retailer app. Once the retailer layaway option has been selected (Step 2 of FIG. 1), the customer may open the scanning utility of the application (Step 3 of FIG. 1) and then scan the electronic tag of the chosen item (Step 4 of FIG. 1). Because the electronic tag is being scanned while in the retailer layaway option, the readout would inform the customer of the cost of the initial layaway payment for the item. Depending on the desires of the retailer, there may be multiple options for the layaway price of the item. For example, the layaway price may be a fixed percentage of the total retail price of the item. Alternatively, the initial layaway payment may vary depending on whether the customer is planning to purchase multiple items. Depending on the preference of the retailer, the initial layaway price may also be a fixed, flat fee independent of the total retail price of the item. Whatever the retailer has determined is the initial layaway price of the scanned item or items, or possibly the multiple options of the initial layaway price of the scanned item or items, such price or prices would be displayed to the user on the screen of the application upon the scan of the chosen item or items. Such a depiction of the electronic data to the user is depicted in FIG. 1 as Step 3 of the first embodiment of the present invention. The readout on the app may also depict various other information that has been stored in the electronic tag, as desired by the retailer. Examples of such information may include, without limitation, the full purchase price of the item scanned; the inventory status of the item scanned; suggested items for purchase similar to the item scanned; and the pricing of competitor retailers for the same or similar items as the item scanned.

After review of the electronic information of the scanned item, which would at a minimum include the layaway price or optional layaway prices of the scanned item, the customer would proceed to Step 5, depending on whether the customer chooses to purchase the item. The customer may choose, as Step 5A, to purchase the item via layaway purchase. The retailer may configure how the purchase is effected, but may choose, for example, to feature a button that says “PURCHASE” or some equivalent on the app screen. The customer would select the purchase option, however it is implemented by the retailer through its retailer app, and would purchase the previously-scanned item via layaway purchase. It may be appreciated that because the customer is using a mobile application to make such a purchase, the purchase itself may be completed either on-site at the retail store, or remotely in any location that the customer accesses the mobile application. Step 6A would effect payment of the item by means desired by the retailer. A first option for effecting payment may include entry of credit card information by the customer. A second option may include logging in under a previously-saved user account of the customer, which would allow the retailer to automatically charge the customer the appropriate price. A third option may be via a third-party payment coordinator. Such options are generally offered by retailers via mobile or online shopping, and would be implemented according to the preference of the retailer into the retailer layaway app.

After providing payment via Step 6A, there may be an additional option, provided in Step 7A, whereby the customer may select a preferred manner of pickup of the purchased item. Because the item has been purchased within a layaway system, the customer will not be physically taking possession of the item at the time of this initial purchase; instead, the customer may choose to return to the retail store at a later date to pick up the item when payment has been completed. Alternatively, the customer may wish to have the item delivered to a different address, such as the home address of the customer. As another alternative, the customer may choose to pick up the item at a different physical store location of the retailer, such as a retailer location in a more convenient place at the time of the completed payment. The retailer layaway option may provide any or all of the above options in Step 7A of the layaway purchase, or may forego this option if it requires only one manner by which the customer picks up the purchased item.

After providing payment and/or selecting manner of pickup of the purchased item, the layaway purchase has been completed, and the customer may leave the store. By using the above app, the customer therefore would avoid the necessity of standing in line to complete the purchase. Because the customer is not taking the item out of the store at the time of purchase, the retailer has no reason to require the customer to stand in such lines to complete the purchase if the retailer allows the use of such a layaway app.

Alternatively, reverting back to Step 5 of the first embodiment of the disclosed invention, the customer may choose not to purchase the item after scanning the item and reviewing the displayed item information. If the customer chooses not to purchase the item, whether via layaway or otherwise, the customer may choose to “store” the item in the app's internal memory (Step 5B). Once stored, the customer may continue scanning additional items and return to the stored item or list of multiple items at a later time. In this manner, by scanning and storing multiple items, the customer may generate a virtual “shopping cart” of potential layaway purchases (Step 6B). As the virtual layaway shopping cart is generated, the retail layaway app would display the individual layaway prices of each scanned item, and would also display the total layaway price of the items as a group. Like the price display discussed above, the price display of the shopping cart may be configured to suit the individual desires of the retailer, and may feature optional displays of alternate prices of the layaway item or list of items.

After storing the items in the virtual shopping cart of the layaway app, the customer may optionally choose items from the virtual shopping cart for layaway purchase (Step 7B). The customer may choose one item or multiple items from the virtual shopping cart for the purchase, and then effect payment according to the methods discussed above in Steps 6A-7A.

Alternatively, reverting again to Step 5, the customer may wish to leave the store without purchasing or saving the scanned item or items. In that instance, the customer may exit the retailer layaway option without storing the scanned item in the virtual shopping cart (Step 5C).

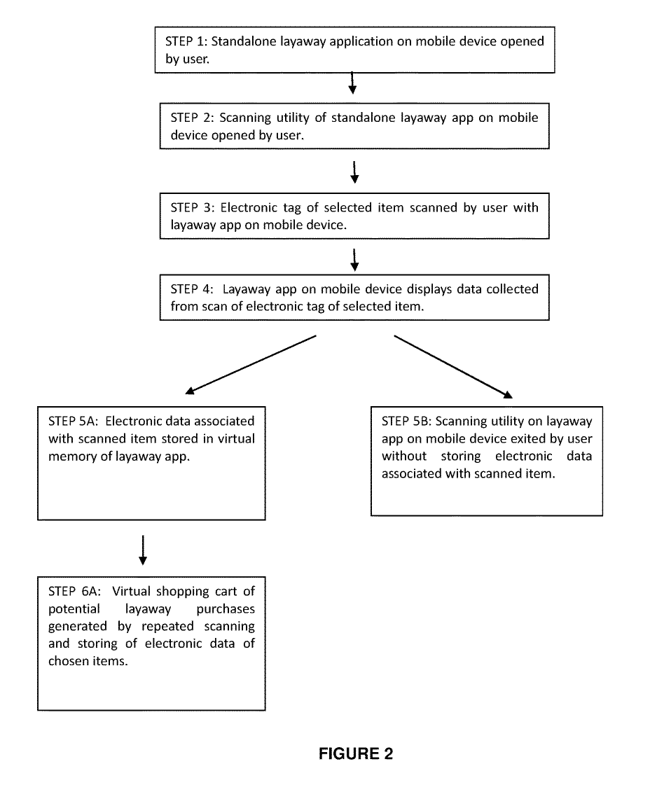

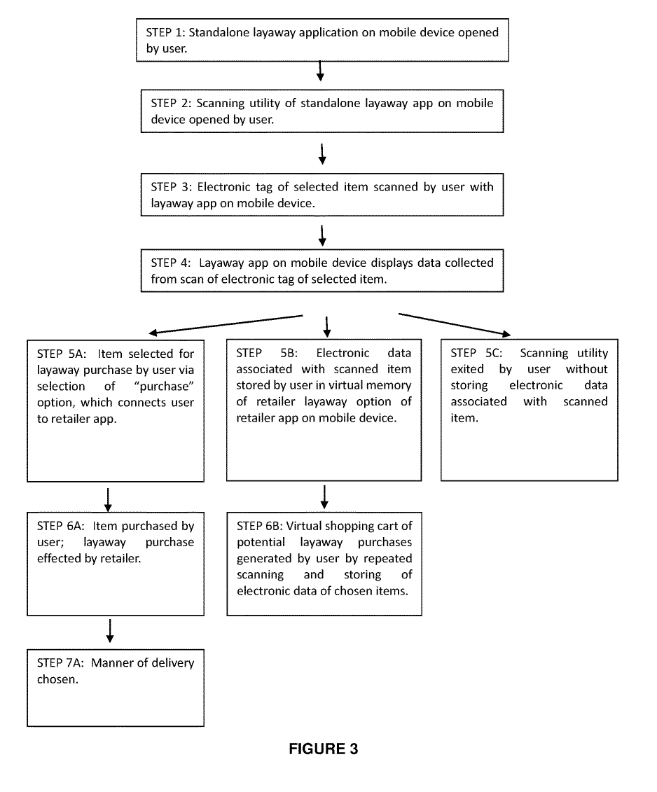

FIGS. 2 and 3 depict an alternate method of operating the disclosed layaway application, whereby the layaway application operates through its own stand-alone app (an “outside layaway app”) rather than through a retailer layaway option within a retailer mobile app. The outside layaway app may be preferred by users who are shopping in a retail store that does not offer a retailer app. Alternatively, it may be employed as a digital hub of multiple retailer mobile applications, representing different retailers. For example, if more than one retailer offers a retailer app that integrates the retailer layaway option discussed above, then the outside layaway app may act as an independent layaway price scanner before proceeding to payment as discussed in Steps 5-7 of FIG. 3, below.

Whether ultimately integrated with the retailer app or not, operation of the outside layaway begins with the user opening the outside layaway app, as listed in Step 1 of FIG. 2. Once opened by the user, the home screen of the outside layaway app would display options, such as “SCAN ITEM,” “OPEN SHOPPING CART,” “PURCHASE ITEM,” or the like. The home screen may feature a number of varied options for the user, but at a minimum would offer an option for the user to scan the electronic tag of the selected item. In Steps 2-3 of the embodiment of FIG. 2, the user would open the scanning utility and then scan the electronic tag of the selected item. In Step 4 of the embodiment of FIG. 2, the outside layaway app would display data stored from the scanned electronic tag, such as the layaway price of the item. As in the embodiment of FIG. 1, because the electronic tag is being scanned through the outside layaway app, the readout would at minimum inform the customer of the initial layaway payment of the item, which may vary depending on factors according to the retailer. Depending on the electronic data available from the scan, the readout on the app may also depict various other information that has been stored in the electronic tag. Examples of such information may include, without limitation, the full purchase price of the item scanned; the inventory status of the item scanned; suggested items for purchase similar to the item scanned; and the pricing of competitor retailers for the same or similar items as the item scanned.

The customer may then choose whether to proceed to Step 5A of the embodiment of FIG. 2, which comprises storing the item in the outside layaway app's virtual memory. Like its equivalent in the embodiment of FIG. 1, the customer may choose to “store” the item in the app's internal memory and then may continue scanning additional items and return to the stored item or list of multiple items at a later time. In this manner, by scanning and storing multiple items, the customer may generate a virtual “shopping cart” of potential layaway purchases (Step 6A of FIG. 2). As the virtual layaway shopping cart is generated, the retail layaway app would display the individual layaway prices of each scanned item, and would also display the total layaway price of the items as a group. Like the price display discussed above, the price display of the shopping cart may be configured to suit the individual desires of the retailer, as programmed by the retailer into the electronic tag of the product, and may feature optional displays of alternate prices of the layaway item or list of items.

Because the virtual memory has the ability to store and reflect the layaway price of the stored, scanned item or items, the customer may review such prices as compared to a similar item for sale in a separate retail store. In this manner, the customer may choose a preferred retailer from which to make the potential layaway purchase.

Alternatively, after scanning an item or items according to Steps 1-4 or 1-5A of the above disclosed embodiment of FIG. 2, the customer may choose to exit the scanning utility of the outside layaway app without storing the electronic data associated with the scanned item. As shown in Step 5B of FIG. 2, the customer may simply close out of the scanning option of the outside layaway app and return to the home screen of the outside layaway app. In following Step 5B of FIG. 2, the customer would not be able to access the electronic data of the stored item at a later time, as the electronic data would not have been saved in the virtual shopping cart of the outside layaway app.

FIG. 3 is the methodology of another embodiment of the outside layaway app, whereby the standalone outside layaway app may act in conjunction with a retailer mobile app and function as a hub for multiple retailer layaway options. In the “layaway hub app” described by the methodology of FIG. 3, the user would first open the layaway hub app, as listed in Step 1. Once opened by the user, the home screen of the layaway hub app would display options, such as “SCAN ITEM,” “OPEN SHOPPING CART,” “PURCHASE ITEM,” or the like. The home screen of the layaway hub app may feature a number of varied options for the user, but at a minimum would offer an option for the user to scan the electronic tag of the selected item.

In Steps 2-4 of the embodiment of FIG. 3, the scanning utility would be opened by the user, the item would be scanned, and the layaway hub app would display data stored from the scanned electronic tag, such as the layaway price of the item. As in the embodiments of FIGS. 1-2, because the electronic tag is being scanned through the layaway hub app, the readout would at a minimum inform the customer of the initial layaway payment of the item, which may vary depending on factors configured by the retailer. Depending on the electronic data available from the scan, the readout on the app may also depict various other information that has been stored in the electronic tag. Examples of such information may include, without limitation, the full purchase price of the item scanned; the inventory status of the item scanned; suggested items for purchase similar to the item scanned; and the pricing of competitor retailers for the same or similar items as the item scanned.

Once the item is scanned according to Steps 2-4, above, the customer may then proceed to Step 5A, purchasing the item via layaway purchase. A preferred embodiment of the disclosed app would feature a virtual button that says “PURCHASE” or an equivalent on the layaway hub app home screen or on the screen displaying the item or items that have been scanned. The customer would select the purchase option, however it is implemented in the layaway hub app, which would connect the user to the independent mobile application and layaway purchase option of the retailer (the “retailer app” and “retailer layaway option” discussed about in connection with FIG. 1). Once the customer is virtually connected to the retailer layaway option, the customer would purchase the previously-scanned item via layaway purchase. It may be appreciated that because the customer is using a mobile application to make such a purchase, the purchase itself may be completed either on-site at the retail store, or remotely in any location that the customer accesses the mobile application. Step 6A would effect payment of the item by means desired by the retailer. A first option for effecting payment may include entry of credit card information by the customer. A second option may include logging in under a previously-saved user account of the customer, which would allow the retailer to automatically charge the customer the appropriate price. A third option may be via a third-party payment coordinator. Such options are generally offered by retailers via mobile or online shopping, and would be implemented according to the preference of the retailer into the retailer layaway app.

After providing payment via Step 6, there may be an additional option, provided in Step 7A, whereby the customer may select a preferred manner of pickup of the purchased item. Because the item has been purchased within a layaway system, the customer will not be physically taking possession of the item at the time of this initial purchase; instead, the customer may choose to return to the retail store at a later date to pick up the item when payment has been completed. Alternatively, the customer may wish to have the item delivered to a different address, such as the home address of the customer. As another alternative, the customer may choose to pick up the item at a different physical store location of the retailer, such as a retailer location in a more convenient place at the time of the completed payment. The retailer layaway option may provide any or all of the above options in Step 7A of the layaway purchase, or may forego this option if it requires only one option for pickup of the purchased item.

Alternatively, reverting back to Step 4 of the third embodiment of the present invention, the customer may choose to simply continue scanning items without purchasing the items on layaway via connection to the retailer application. If the customer does not wish to make a purchase, the user would remain scanning, and optionally storing the electronic data associated with the scanned item or items, within the standalone layaway application. As shown in Steps 5B-6B of FIG. 3, the user may choose to scan and store electronic data associated with the scanned item or items in the virtual memory of the layaway hub app, generating a virtual shopping cart of potential layaway purchases. Alternatively, the user may choose to exit the scanning utility without saving the electronic data of the scanned item or items (Step 5C of FIG. 3). In each of Steps 5B-6B and 5C, the user would remain within the standalone layaway hub app, without connecting to the retailer's own mobile application. The retailer's own mobile application would only be connected to if the customer chose to purchase an item or items on layaway.

It may be appreciated that via the above disclosed methods, the customer is provided with a convenient mobile option to track layaway prices of various items scanned in person at a retail store. Additionally, although the customer is present in the store, which allows the customer to physically examine the potential items to be purchased in person, the customer is not required to stand in line when making a layaway purchase.

Many changes and modifications can be made in the present invention without departing from the spirit thereof. I therefore pray that my rights to the present invention be limited only by the scope of the appended claims.

I claim:

1. A method for making a purchase via a mobile application, comprising the steps of:
(i) opening a mobile application on a mobile device;
(ii) scanning an electronic identifier of a selected item within a retail store with said mobile application; and
(iii) purchasing a scanned item from said retail store with said mobile application on said mobile device.

2. The method of claim 1, wherein said purchasing a scanned item further comprises:
(a) whereby said retail store offers said scanned item for purchase for a price less than the total retail price associated with said scanned item; and
(b) a customer pays said price less than the total retail price associated with said scanned item with said mobile application on said mobile device.

3. The method of claim 2, further comprising:
(iv) choosing a manner of delivery of said purchased item.

4. The method of claim 2, further comprising:
(iv) choosing a manner of delivery of said purchased item, where said manner of delivery is chosen from the options of:
(a) pickup of said purchased item in said retail store;
(b) pickup of said purchased item in a different retail store location than said retail store; and
(c) delivery of said purchased item to a shipping address of said customer's choosing.

5. A mobile application, comprising:
(i) a scanning utility with the ability to scan electronic data associated with an item in a retail store;
(ii) a screen to display electronic data associated with a scanned item in a retail store; and
(iii) memory to store said electronic data associated with a scanned item in a retail store,
whereby a user of said mobile application can scan a selected item in a retail store, view said electronic data associated with said scanned item on said screen of said mobile application, and purchase said scanned item with said mobile application.

6. The mobile application of claim 5, wherein said screen further comprises a display of a price to purchase said scanned item according to a layaway policy of said retail store.

7. A method for use in a retail store that offers an item for purchase by layaway payment, comprising the steps:
(i) opening a mobile application, said mobile application comprising:
(a) a scanning utility capable of reading electronic data associated with an item in a retail store that offers said item for purchase by layaway payment;
(b) a screen to display electronic data associated with a scanned item; and
(c) memory to store said electronic data associated with said scanned item;
(ii) selecting a selected item within a retail store that offers said selected item for purchase by layaway payment,
wherein said selected item costs a total retail price, and
wherein said selected item may be purchased by payment of a price lower than said total retail price;
(iii) scanning an electronic identifier of said selected item; and
(iv) viewing electronic data displayed by said screen of said mobile application,
wherein said electronic data includes said price lower than said total retail price of said selected item, and wherein display of said electronic data includes displaying said price lower than said total retail price of said selected item.

8. The method of claim 7, further comprising:
(v) purchasing said selected item by payment of said price lower than said total retail price of said selected item.

9. The method of claim 7, further comprising:
(v) storing said electronic data associated with said selected item in virtual memory of said mobile application.

10. The method of claim 7, further comprising:
(v) storing said electronic data associated with said selected item in virtual memory of said mobile application;
(vi) selecting a second selected item within a retail store that offers said selected item for purchase by layaway payment,
wherein said second selected item costs a second total retail price; and
wherein said second selected item may be purchased by payment of a second price lower than said second total retail price;
(vii) scanning an electronic identifier of said second selected item; and
(viii) viewing electronic data displayed by said screen of said mobile application,
wherein said electronic data includes said second price lower than said second total retail price of said selected item, and wherein display of said electronic data includes displaying said second price lower than said second total retail price of said second selected item.

11. The method of claim 10, further comprising:
(ix) storing said electronic data associated with said second selected item in virtual memory of said mobile application; and
(x) generating a virtual shopping cart from said virtual memory of said mobile application, wherein said virtual shopping cart displays:
(a) said price lower than total said retail price of said selected item;
(b) said second price lower than said second total retail price of said second selected item; and
(c) a total price reflecting the total price of said price lower than said total retail price of said selected item and said second price lower than said second total retail price of said second selected item.

12. The method of claim 11, further comprising:
(xi) choosing one or more selected items displayed on said virtual shopping cart for purchase; and
(xii) purchasing said one or more selected items from said retail store with said mobile application on said mobile device.

13. A mobile application for making a layaway purchase in a retail store, the mobile application comprising:
(i) a scanning utility capable of reading electronic data associated with an item in a retail store that offers said item for purchase by layaway payment;
(ii) a screen to display electronic data associated with a scanned item; and
(iii) memory to store said electronic data associated with said scanned item;
whereby a user may use said mobile application to purchase an item a retail store that offers an item for purchase by layaway payment, comprising the steps:
(a) opening said mobile application;
(b) selecting a selected item within a retail store that offers said selected item for purchase by layaway payment,
wherein said selected item costs a total retail price; and
wherein said selected item may be purchased by payment of a price lower than said total retail price;
(c) scanning an electronic identifier of said selected item; and
(d) viewing electronic data displayed by said screen of said mobile application,
wherein said electronic data includes said price lower than said total retail price of said selected item, and wherein display of said electronic data includes displaying said price lower than said total retail price of said selected item.

14. The mobile application of claim 13, further comprising:
(e) purchasing said selected item by payment of said price lower than said total retail price of said selected item.

15. The mobile application of claim 13, further comprising:
(e) storing said electronic data associated with said selected item in virtual memory of said mobile application;
(f) selecting a second selected item within a retail store that offers said selected item for purchase by layaway payment,
wherein said second selected item costs a second total retail price; and
wherein said second selected item may be purchased by payment of a second price lower than said second total retail price;
(g) scanning an electronic identifier of said second selected item; and
(h) viewing electronic data displayed by said screen of said mobile application,
wherein said electronic data includes said second price lower than said second total retail price of said selected item, and wherein display of said electronic data includes displaying said second price lower than said second total retail price of said second selected item.

16. The mobile application of claim 15, further comprising:
(i) storing said electronic data associated with said second selected item in virtual memory of said mobile application; and
(j) generating a virtual shopping cart from said virtual memory of said mobile application, wherein said virtual shopping cart displays:
(1) said price lower than total said retail price of said selected item;
(2) said second price lower than said second total retail price of said second selected item; and
(3) a total price reflecting the total price of said price lower than said total retail price of said selected item and said second price lower than said second total retail price of said second selected item.

17. The mobile application of claim 16, further comprising:
(k) choosing one or more selected items displayed on said virtual shopping cart for purchase; and
(l) purchasing said one or more selected items from said retail store with said mobile application on said mobile device.
